(19) United States
(12) Patent Application Publication
(10) Pub. No.: US 2025/0300304 A1
(43) Pub. Date: Sep. 25, 2025

(54) POWER SUPPLY APPARATUS

(71) Applicant: TOYOTA JIDOSHA KABUSHIKI KAISHA, Aichi-ken (JP)

(72) Inventors: Takenori MIKAMI, Miyoshi-Shi (JP); Kenji BABA, Seto-shi (JP); Toshio UCHIYAMA, Toyota-shi (JP); Kenji TAKAHASHI, Toyota-shi (JP)

(21) Appl. No.: 19/056,739

(22) Filed: Feb. 19, 2025

(30) Foreign Application Priority Data
Mar. 21, 2024 (JP) 2024-045598

(51) Int. Cl. H01M 50/289; H01M 50/209; H01M 50/251; H01M 50/264

(52) U.S. Cl. CPC H01M 50/289; H01M 50/209; H01M 50/251; H01M 50/264

(57) ABSTRACT

A power supply apparatus accommodates plural rechargeable batteries at multiple levels, in a height direction, of the power supply apparatus, each rechargeable battery includes a first region and a second region, the first region is provided substantially in a horizontal direction at a rechargeable battery, and the second region is within the first region and is formed to be thicker, in the height direction, than the first region. A first rechargeable battery and a second rechargeable battery that is adjacent to the first rechargeable battery in the height direction are arranged to be offset in a front-rear direction of the power supply apparatus, and a distance, in the height direction, between a bottom face of the first rechargeable battery and a bottom face of the second rechargeable battery is less than a thickness dimension, in the height direction, of the second region of the first rechargeable battery.

### CROSS-REFERENCE TO RELATED APPLICATION

This application claims priority under 35 USC 119 from Japanese Patent Application No. 2024-045598 filed Mar. 21, 2024, the disclosure of which is incorporated by reference herein in its entirety.

### BACKGROUND

### Technical Field

The present disclosure relates to a power supply apparatus.

### Related Art

Japanese Patent Application Laid-Open (JP-A) No. 2001-015090 discloses a technology relating to a rechargeable battery storage apparatus that includes rechargeable battery storage boxes capable of storing plural rechargeable batteries, and a storage box housing body that is capable of storing plural number of the rechargeable battery storage boxes.

The regularly shaped, substantially cuboid rechargeable battery accommodation boxes in which the rechargeable batteries are accommodated are accommodated in this rechargeable battery storage apparatus.

### SUMMARY

In JP-A No. 2001-015090, the shapes of the rechargeable battery accommodation boxes are substantially cuboid. The plural rechargeable battery accommodation boxes that are formed in the regular, substantially cuboid shapes can be accommodated in the rechargeable battery storage apparatus.

However, when the rechargeable batteries that are being accommodated are reusable products to be used for various alternative applications, and particularly rechargeable battery packs to be used in automobiles, rechargeable batteries that include regions with different thicknesses in the same rechargeable battery may be accommodated. If the rechargeable batteries are accommodated at multiple levels in a height direction to fit regions of greater thickness of the rechargeable battery packs, an overall height is greater, a center of gravity is raised, and earthquake resistance may be degraded.

In consideration of the circumstances described above, an object of the present disclosure is to provide a power supply apparatus that may suppress the height of a center of gravity and improve earthquake resistance even if rechargeable batteries including regions with different thicknesses are accommodated at plural levels.

A power supply apparatus according to a first aspect of the present disclosure is configured to accommodate plural rechargeable batteries at multiple levels, in a height direction, of the power supply apparatus. The plural rechargeable batteries include a first rechargeable battery that has a first region and a second region, the first region being provided substantially in a horizontal direction at the first rechargeable battery, and the second region being within the first region and being formed to be thicker, in the height direction, than the first region. The power supply apparatus enables arrangement of the first rechargeable battery and a second rechargeable battery that is adjacent to the first rechargeable battery in the height direction, the first rechargeable battery and the second rechargeable battery are arranged to be offset in a front-rear direction of the power supply apparatus such that the second rechargeable battery is disposed at an upper side or a lower side of the first region excluding the second region of the first rechargeable battery, and a distance, in the height direction, between a bottom face of the first rechargeable battery and a bottom face of the second rechargeable battery is less than a thickness dimension of the second region of the first rechargeable battery, in the height direction of the second region of the first rechargeable battery.

In the power supply apparatus according to the first aspect, the plural rechargeable batteries are accommodated at multiple levels, in the height direction, of the power supply apparatus. The first rechargeable battery includes the first region and the second region. The first region is provided substantially in the horizontal direction at the first rechargeable battery, and the second region is within the first region and is formed to be thicker, in the height direction, than the first region of the first rechargeable battery,

In the power supply apparatus, the second rechargeable battery that is adjacent to the first rechargeable battery in the height direction is arranged to be offset in the front-rear direction of the power supply apparatus, such that the second rechargeable battery is disposed at the upper side or the lower side of the first region excluding the second region of the first rechargeable battery. Thus, the first rechargeable battery and the second rechargeable battery may be disposed such that the distance between the bottom face of the first rechargeable battery and the bottom face of the second rechargeable battery is less than the thickness dimension of the second region of the first rechargeable battery.

A structure can be mentioned as a comparative example in which a first rechargeable battery and a second rechargeable battery are disposed such that a distance between a bottom face of the first rechargeable battery and a bottom face of the second rechargeable battery is greater than a thickness dimension of a second region of the first rechargeable battery, for example, a structure in which the second rechargeable battery is disposed at an upper side of the second region of the first rechargeable battery. Compared with this structure, a height dimension of the first rechargeable battery and second rechargeable battery may be reduced in the power supply apparatus of the present disclosure.

That is, in the power supply apparatus according to the first aspect, even when, for example, the second rechargeable battery is provided with a third region provided substantially in the horizontal direction and a fourth region formed with greater thickness in the height direction than the third region, the first and the second rechargeable batteries may be offset in the front-rear direction of the power supply apparatus such that the second region of the first rechargeable battery and the fourth region of the second rechargeable battery are not vertically superposed with one another in the height direction.

Therefore, an overall height of the first and second rechargeable batteries accommodated at multiple levels in the power supply apparatus may be made less than in the comparative example, in which rechargeable batteries are accommodated with a second region of a first rechargeable battery and a fourth region of a second rechargeable battery being vertically superposed with one another in the height direction. Consequently, the center of gravity of the power supply apparatus may be lowered, and earthquake resistance of the power supply apparatus accommodating the rechargeable batteries may be improved. Note that the first region is provided substantially in the horizontal direction but an upper face thereof is not necessarily formed in a flat shape and may be formed with protrusions and recesses.

In a power supply apparatus according to a second aspect of the present disclosure, the power supply apparatus according to the first aspect includes: a power supply apparatus main body; and at least two pairs of attachments that extend in a front-rear direction of the power supply apparatus main body and that support respective both end portions, in a width direction, of the rechargeable batteries, the width direction of the rechargeable batteries being substantially orthogonal to an insertion and removal direction of the rechargeable batteries with respect to the power supply apparatus. Each pair of attachments is formed to be shorter than a dimension of the power supply apparatus main body, in the front-rear direction of the power supply apparatus main body, and at least two pairs of the attachments that are disposed to be adjacent in the height direction are arranged offset in the front rear direction of the power supply apparatus.

In the power supply apparatus according to the second aspect, at least two pairs of the attachments are provided. The two pairs of attachments extend, in the front-rear direction, of the power supply apparatus main body, and respectively support both end portions, in the width direction, of the rechargeable batteries, the width direction is substantially orthogonal to the insertion and removal direction of the rechargeable batteries with respect to the power supply apparatus.

Each pair of attachments is formed to be shorter than the dimension of the power supply apparatus main body, in the front-rear direction of the power supply apparatus main body, and the pairs of attachments that are adjacent in the height direction are arranged offset in the front-rear direction of the power supply apparatus. Therefore, the first rechargeable battery and the second rechargeable battery may be arranged offset in the front-rear direction of the power supply apparatus.

In a power supply apparatus according to a third aspect of the present disclosure, the power supply apparatus according to the first aspect further includes an insertion and removal aperture at which the rechargeable batteries are inserted and removed substantially horizontally in the front-rear direction of the power supply apparatus. The insertion and removal aperture is provided at one end side of the power supply apparatus main body, in the front-rear direction of the power supply apparatus main body.

The power supply apparatus according to the third aspect includes the insertion and removal aperture at which the rechargeable batteries are inserted and removed substantially horizontally in the front-rear direction of the power supply apparatus. The insertion and removal aperture is provided at one side of the power supply apparatus main body, in the front-rear direction of the power supply apparatus main body. The rechargeable batteries can be inserted into and removed from the power supply apparatus through the insertion and removal aperture.

In a power supply apparatus according to a fourth aspect of the present disclosure, in the power supply apparatus according to the third aspect, the insertion and removal aperture is provided at the one end side and another end side of the power supply apparatus main body, in the front-rear direction of the power supply apparatus main body.

In the power supply apparatus according to the fourth aspect, because the insertion and removal aperture is provided at the one end side and at the other end side of the power supply apparatus main body, in the front-rear direction of the power supply apparatus main body. In the rechargeable batteries that are arranged along the height direction and that are arranged offset at front and rear in the front-rear direction, sides of the rechargeable batteries at which thicker portions are provided are arranged at sides of the power supply apparatus at which the insertion and removal apertures are provided. Therefore, the rechargeable batteries may be easily inserted into and removed from the power supply apparatus, and operator performance is improved.

In a power supply apparatus according to a fifth aspect of the present disclosure, in the power supply apparatus according to the first aspect, the second rechargeable battery includes a third region and a fourth region, the third region being provided substantially in the horizontal direction at the second rechargeable battery, and the fourth region being within the third region and being formed to be thicker, in the height direction, than the third region of the second rechargeable battery, and the first rechargeable battery and second rechargeable battery are arranged such that the second region of the first rechargeable battery and the fourth region of the second rechargeable battery are not vertically superposed.

In the power supply apparatus according to the fifth aspect, the second rechargeable battery includes the third region and the fourth region. The third region is provided substantially in the horizontal direction, and the fourth region is within the third region and is formed to be thicker, in the height direction, than the third region.

The second region of the first rechargeable battery and the fourth region of the second rechargeable battery are disposed so as not to be vertically superposed with one another. Therefore, an overall height of the rechargeable batteries accommodated at multiple levels in the power supply apparatus of the present disclosure may be made less than a comparative example in which a second region of a first rechargeable battery and a fourth region of a second rechargeable battery are vertically superposed with one another in the height direction.

Consequently, the center of gravity of the power supply apparatus accommodating the rechargeable batteries may be lowered, and earthquake resistance of the power supply apparatus may be improved. Note that the third region is provided substantially in the horizontal direction but an upper face thereof is not necessarily formed in a flat shape and may be formed with protrusions and recesses.

In a power supply apparatus according to a sixth aspect of the present disclosure, in the power supply apparatus according to the fifth aspect, the second region is disposed at a rear side of the power supply apparatus main body, in the front-rear direction of the power supply apparatus main body, and the fourth region is disposed at a front side of the power supply apparatus main body, in the front-rear direction of the power supply apparatus main body.

In the power supply apparatus according to the sixth aspect, the second region of the first rechargeable battery is disposed at the rear side of the power supply apparatus main body, and the fourth region of the second rechargeable battery is disposed at the front side of the power supply apparatus main body. Therefore, weights at the front and rear of the power supply apparatus, in the front-rear direction of the power supply apparatus may be in balance, and earthquake resistance of the power supply apparatus may be improved.

As described above, a power supply apparatus according to the present disclosure may lower the height of a center of gravity and improve earthquake resistance even if rechargeable batteries including regions with different thicknesses are accommodated at plural levels

### BRIEF DESCRIPTION OF THE DRAWINGS

FIG. 1 is a schematic perspective view showing a power supply apparatus according to a present exemplary embodiment;

FIG. 2 is a schematic side section diagram showing a state in which plural battery packs are accommodated in the power supply apparatus according to the present exemplary embodiment;

FIG. 3 is a schematic perspective view showing a battery pack to be accommodated in the power supply apparatus according to the present exemplary embodiment; and

FIG. 4 is a schematic perspective view showing another battery pack to be provided in the power supply apparatus according to the present exemplary embodiment.

### DETAILED DESCRIPTION

A power supply apparatus according to an exemplary embodiment of the present disclosure is described using the attached drawings.

### —Structure of the Power Supply Apparatus—

First, structures of the power supply apparatus according to the exemplary embodiment of the present disclosure are described.

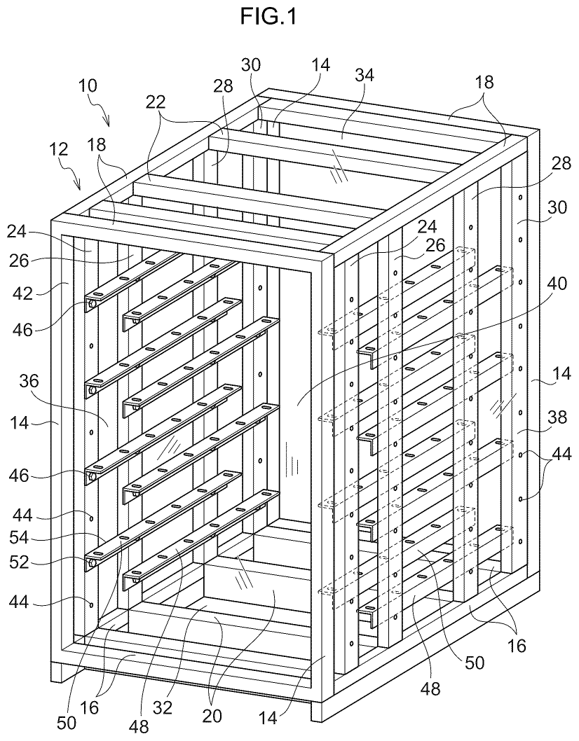

FIG. 1 shows a battery pack accommodation apparatus 10 that serves as the power supply apparatus according to the present exemplary embodiment. The battery pack accommodation apparatus 10 is a casing body (a power supply apparatus main body) 12 formed in a rectangular box shape. A framework of the battery pack accommodation apparatus 10 includes pillar members 14, which extend in the vertical direction of the casing body 12, and beam members such as lower beam members 16 and upper beam members 18, which extend in the front-rear direction of the casing body 12, and the like. These members are depicted with rectangular solid shapes but, for example, U steel, H steel or the like can be used.

The pillar members 14 are provided at corner portions of the battery pack accommodation apparatus 10. The lower beam members 16 span between lower ends of the pillar members 14 that are disposed adjacent to one another, and the upper beam members 18 span between upper ends of the pillar members 14 that are disposed adjacent to one another.

Plural lower beam members 20 span in a width direction of the battery pack accommodation apparatus 10 between the pair of lower beam members 16 that are provided along the front-rear direction of the battery pack accommodation apparatus 10 and that oppose one another. Plural upper beam members 22 span in the width direction of the battery pack accommodation apparatus 10 between the pair of upper beam members 18 that are provided along the front-rear direction of the battery pack accommodation apparatus 10 and that oppose one another.

In the present exemplary embodiment, as an example, four pillar members 24, 26, 28 and 30 are provided upright respectively between the pillar members 14 that are disposed at front and rear positions in the front-rear direction of the battery pack accommodation apparatus 10.

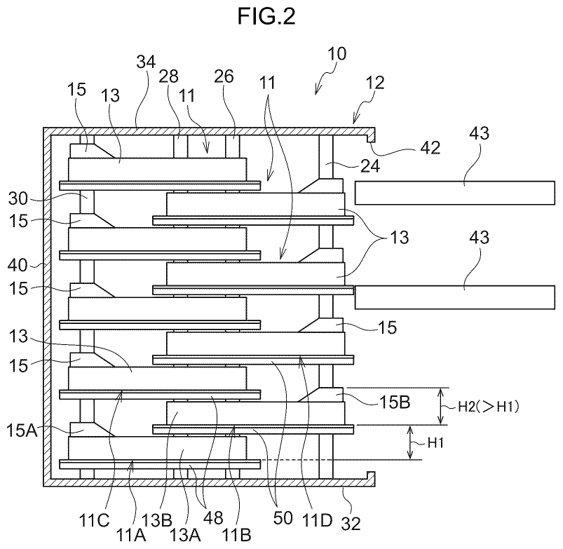

In the present exemplary embodiment, the battery pack accommodation apparatus 10 includes a lower wall portion 32, an upper wall portion 34, a pair of side wall portions 36 and 38, and a back wall portion 40. An insertion and removal aperture 42 is provided at a front side of the battery pack accommodation apparatus 10. Battery packs 11 that serve as rechargeable batteries (see FIG. 2) can be inserted and removed at the insertion and removal aperture 42.

An opening and closing door, which is not shown in the drawings, is provided at the insertion and removal aperture 42. The interior of the battery pack accommodation apparatus 10 may be opened up and closed off by the opening and closing door. That is, when the opening and closing door is closed, the battery pack accommodation apparatus 10 becomes an enclosed space. Accordingly, in a state in which the insertion and removal aperture 42 is opened, the battery packs 11 may be inserted into and removed from the battery pack accommodation apparatus 10 substantially in the horizontal direction through the insertion and removal aperture 42, by means of dedicated jigs 43 (see FIG. 2).

In FIG. 1, the lower wall portion 32, upper wall portion 34, pair of side wall portions 36 and 38, and back wall portion 40 are depicted as transparent boards so as to enable understanding of structures inside the battery pack accommodation apparatus 10. However, these wall members do not need to be transparent.

Plural fixing holes 44 are formed along the height direction at each of the pillar members 24, 26, 28 and 30. Fasteners 46 such as bolts or the like may be fixed through these fixing holes 44. Attachments 48 and 50 may be fixed to the pillar members 24, 26, 28 and 30.

The attachments 48 and 50 are formed, for example, to be shorter than a dimension of the battery pack accommodation apparatus 10 in the front-rear direction of the battery pack accommodation apparatus 10. The attachments 48 span (extend) substantially in the horizontal direction between the pillar members 26, 28 and 30. The attachments 50 span substantially in the horizontal direction between the pillar members 24, 26 and 28.

In the present exemplary embodiment, the four pillar members 24, 26, 28 and 30 are provided upright respectively between the pillar members 14 that are disposed at front and rear positions of the battery pack accommodation apparatus 10, in the front-rear direction of the battery pack accommodation apparatus 10. However, one pillar member may be disposed between the respective pillar members 14.

The attachments 48 and 50 are formed of, for example, steel plate in substantial “L” shapes. Each of the attachments 48 and 50 includes two fixing sides 52 and 54 that are orthogonal to one another. The one fixing side 52 is fixable to the pillar members 24, 26, 28 and 30, and the other fixing piece 54 is fixable to one of the battery packs 11.

In the present exemplary embodiment, each attachment 48 is fixed to the pillar members 26, 28 and 30, and each attachment 50 is fixed to the pillar members 24, 26 and 28. In the height direction of the battery pack accommodation apparatus 10, the attachments 48 and 50 are arranged in states that the attachments 48 and 50 are offset in the front-rear direction.

In the present exemplary embodiment, as illustrated in FIG. 1 and FIG. 2, the attachments 48 are disposed at arear side of the interior of the battery pack accommodation apparatus 10, and the attachments 50 are disposed at a front side of the interior of the battery pack accommodation apparatus 10. The battery packs 11 are respectively supported by the attachments 48 and 50.

Thus, in the present exemplary embodiment, for example, a battery pack 11A and a battery pack 11B, the battery pack 11B and a battery pack 11C, and the battery pack 11C and a battery pack 11D, respectively, are adjacent in the height direction and can be disposed in states that they are offset in the front-rear direction.

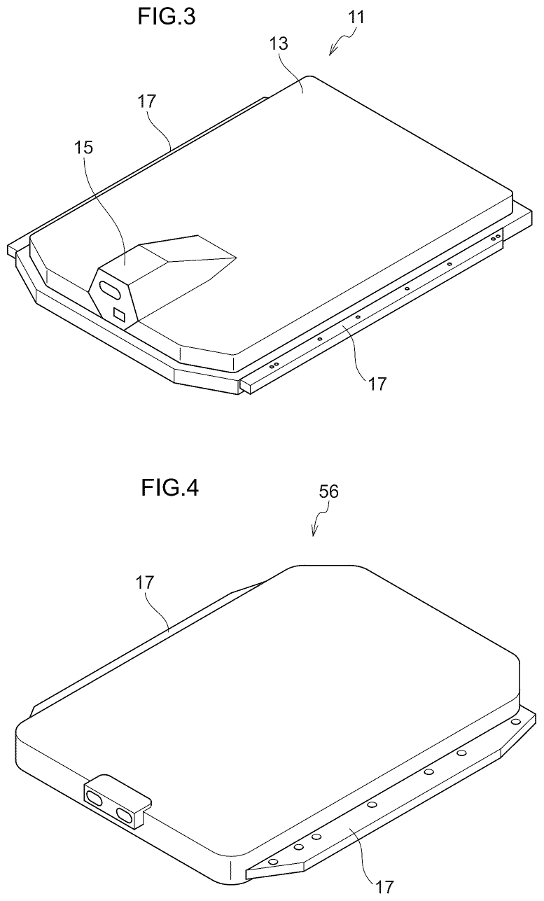

As illustrated in FIG. 3, each battery pack 11 includes a base portion 13 (a first region and a third region) and a thicker portion 15 (a second region and a fourth region). The base portion 13 is provided substantially in the horizontal direction and formed in a substantially rectangular board shape in plan view. The thicker portion 15 is within the base portion 13 and is formed to be thicker, in a height direction, than the base portion 13. In the present exemplary embodiment, the base portion is formed in a substantially rectangular board shape and an upper face thereof is formed in a flat shape, but these are not limiting; protrusions and recesses may be formed at the upper face.

Flanges 17 project to outer sides from both end portions, in a width direction, of the battery pack 11. Although not shown in the drawings, the battery pack 11 can be attached to a pair of rockers via the flanges 17. The rockers respectively extend in a vehicle front-rear direction at two end portions, in a width direction, of a floor panel of a vehicle.

In a state in which the flanges 17 abut against the attachments 48 and 50, the flanges 17 are fastened via fasteners, which are not shown in the drawings. Thus, the battery pack 11 is fixed to the attachments 48 and 50. Note that the shape of the battery pack 11 as depicted in FIG. 2 is simplified.

### —Operation and Effects of the Power Supply Apparatus—

Now, operation and effects of the power supply apparatus according to the exemplary embodiment of the present disclosure are described.

In the present exemplary embodiment, as shown in FIG. 1 and FIG. 2, the battery pack accommodation apparatus 10 plurally accommodates the battery packs 11 at multiple levels in the height direction. The battery pack accommodation apparatus 10 includes the insertion and removal aperture 42, and the battery packs 11 are inserted and removed substantially in the horizontal direction by means of the dedicated jigs 43.

The battery pack accommodation apparatus 10 is formed to be longer in the front-rear direction than a dimension in the insertion and removal direction of the battery pack 11. In the battery pack accommodation apparatus 10, the battery packs 11 that are adjacent in the height direction may be arranged in states that the battery packs 11 are offset in the front-rear direction (described below).

In the present exemplary embodiment, with the battery pack accommodation apparatus 10 being formed to be longer in the front-rear direction of the battery pack accommodation apparatus 10, than the dimension of the battery pack 11 in the insertion and removal direction of the battery pack 11, the arrangement of the battery packs 11 that are adjacent in the height direction in states that the battery packs 11 are offset in the front-rear direction is enabled. Therefore, in the present exemplary embodiment the battery packs 11 may be offset in the front-rear direction such that the thicker portions 15 provided at the battery packs 11 are not vertically superposed with one another in the height direction.

Consequently, in the present exemplary embodiment an overall height of the battery packs 11 that are accommodated at multiple levels may be made lower than in, as a comparative example that is not shown in the drawings, a structure in which the battery packs 11 are disposed with the thicker portions 15 being vertically superposed with one another in the height direction. Thus, in the present exemplary embodiment, the center of gravity of the battery pack accommodation apparatus 10 may be lowered and earthquake resistance may be improved.

In the present exemplary embodiment, the battery pack accommodation apparatus 10 includes the plural pillar members 24, 26, 28 and 30 and the attachments 48 and 50. The attachments 48 and 50 are formed to be shorter than the dimension of the battery pack accommodation apparatus 10, in the front-rear direction of the battery pack accommodation apparatus 10, the attachments 48 are fixed to the pillar members 26, 28 and 30, and the attachments 50 are fixed to the pillar members 24, 26 and 28.

That is, along the height direction, the attachments 48 and 50 are arranged in states that the attachments 48 and 50 are offset to front and rear at the battery pack accommodation apparatus 10. Thus, the battery packs 11 may be arranged in the states that the battery packs 11 are offset to front and rear at the battery pack accommodation apparatus 10, along the height direction, by the battery packs 11 being fixed to the respective attachments 48 or 50.

Although not illustrated in the drawings, stoppers may be provided at rear ends of the attachments 48 and 50. Thus, when each battery pack 11 is being accommodated in the battery pack accommodation apparatus 10, movement of the battery pack 11 may be limited by the battery pack 11 abutting against the stoppers.

Now, details of the offsets of the battery packs 11 in the front-rear direction are more specifically described.

In the present exemplary embodiment as described above, the attachments 48 are disposed at the rear side of the interior of the battery pack accommodation apparatus 10 and the attachments 50 are disposed at the front side of the interior of the battery pack accommodation apparatus 10. The attachments 48 and the attachments 50 are arranged, along the height direction of the battery pack accommodation apparatus 10, in states that the attachments 48 and the attachments 50 are offset to front and rear at the battery pack accommodation apparatus 10. At a lowermost level of the battery pack accommodation apparatus 10, the attachments 48 are disposed at the rear side of the interior of the battery pack accommodation apparatus 10.

The battery packs 11 are successively accommodated from the lower levels of the battery pack accommodation apparatus 10. Therefore, at the lowermost level of the battery pack accommodation apparatus 10, the battery pack 11A is fixed to the attachments 48 such that a thicker portion 15A thereof is at the rear side of the interior of the battery pack accommodation apparatus 10.

The attachments 50 are provided at the upper side of these attachments 48 and are disposed at the front side of the interior of the battery pack accommodation apparatus 10. Therefore, the battery pack 11B is fixed to these attachments 50 at the upper side of the battery pack 11A, in a state in which a base portion 13B of the battery pack 11B is superposed in plan view with a base portion 13A of the battery pack 11A, such that a thicker portion 15B of the battery pack 11B is at the front side of the interior of the battery pack accommodation apparatus 10.

As described above, the battery packs 11A and 11B that are adjacent in the height direction in the battery pack accommodation apparatus 10 are arranged in the states that the battery packs 11A and 11B are offset in the front-rear direction of the battery pack accommodation apparatus 10. Thus, the battery packs 11A and 11B may be disposed such that a distance H1 between a floor face of the battery pack 11A and a floor face of the adjacent battery pack 11B is less than a thickness dimension H2 of the thicker portion 15B of the battery pack 11B (H2>H1). The same applies to the battery packs 11C and 11D and so forth.

As a comparative example, the battery packs 11A and 11B may be disposed such that the distance H1 between the floor face of the battery pack 11A and the floor face of the battery pack 11B is greater than the thickness dimension H2 of the thicker portion 15B of the battery pack 11B (H2<H1). For example, although not shown in the drawings, a structure may be mentioned in which the battery pack 11B is disposed at the upper side of the thicker portion 15A of the battery pack 11A. In comparison with this structure, a height dimension of the battery pack 11A with the battery pack 11B may be reduced in the present exemplary embodiment.

That is, in the present exemplary embodiment the battery packs 11A and 11B that are adjacent in the height direction are arranged in the states that the battery packs 11A and 11B are offset in the front-rear direction of the battery pack accommodation apparatus 10 such that the thicker portion 15A of the battery pack 11A and the thicker portion 15B of the battery pack 11B are not vertically superposed.

In this way, the battery packs 11 that are adjacent in the height direction are disposed such that the base portions 13 are superposed in plan view but the thicker portions 15 are not vertically superposed with one another. The present exemplary embodiment is specified such that the thicker portions 15 are alternatingly disposed at the rear side and the front side of the interior of the battery pack accommodation apparatus 10. Thus, the overall height of the battery packs 11 disposed in the battery pack accommodation apparatus 10 may be reduced.

The present exemplary embodiment is specified such that the thicker portions 15 of the battery packs 11 that are adjacent in the height direction are alternatingly disposed at the rear side and the front side of the interior of the battery pack accommodation apparatus 10. Thus, weights at the front and rear of the battery pack accommodation apparatus 10 may be in balance, and earthquake resistance of the battery pack accommodation apparatus 10 that has accommodated the battery packs 11 may be improved.

In the present exemplary embodiment, the insertion and removal aperture 42 of the battery pack accommodation apparatus 10 is provided at one end side, in the front-rear direction, of the battery pack accommodation apparatus 10, and the battery packs 11 are inserted into and removed from the battery pack accommodation apparatus 10 via the insertion and removal aperture 42, but this is not limiting.

For example, although not shown in the drawings, insertion and removal apertures may be provided at the one end side and at the other end side, in the front-rear direction, of the battery pack accommodation apparatus 10. Thus, of each battery pack 11 arranged with an offset to front or rear in the front-rear direction of the battery pack accommodation apparatus 10, the side thereof at which the thicker portion 15 is provided may be disposed at either side at which an insertion and removal aperture is provided.

Consequently, the battery packs 11 may be easily inserted in and removed from the battery pack accommodation apparatus 10, and operator performance is improved. In many battery packs, the thicker portion 15 is greater in weight than the base portion 13. Therefore, the center of gravity of the battery pack 11 is often disposed at the side thereof at which the thicker portion 15 is provided. Therefore, disposing the thicker portion 15 side of each battery pack 11 at either side at which an insertion and removal aperture is provided makes insertion and removal of the battery pack 11 at the battery pack accommodation apparatus 10 easier.

### Supplementary Descriptions of the Exemplary Embodiment

In the exemplary embodiment described above, a description is given of the flanges 17 of the battery packs 11 being fixed to the attachments 48 and 50. However, the flanges 17 are not necessarily required, and may be provided at only one side, in the width direction, of each battery pack 11. It is also possible that no flange 17 is formed, depending on the battery pack 11. In particular, when no flange 17 is formed at a stationary-type rechargeable battery or the like, width direction end portions of this battery pack 11 are fixed to the attachments 48 or 50.

In the present exemplary embodiment, the attachments 48 and 50 are formed to be shorter than the front-rear direction dimension of the battery pack accommodation apparatus 10. However, this is not limiting, given that it is sufficient that a thicker portion 15 of each battery pack 11 is disposed in a state that the thicker portion 15 is offset in the front-rear direction relative to a battery pack 11 that is adjacent in the height direction.

That is, it is sufficient that at least thicker portions 15 of battery packs 11 that are adjacent in the height direction are not superposed with one another in the vertical direction. Therefore, attachments 48 and 50 may have substantially the same dimensions of the battery pack accommodation apparatus 10, in the front-rear direction of the battery pack accommodation apparatus 10.

In the present exemplary embodiment, the battery packs 11 are rechargeable batteries, and plural rechargeable batteries are accommodated in the battery pack accommodation apparatus 10. In the present exemplary embodiment, the battery packs 11 that have partially varying height dimensions may be accommodated, but it is not necessarily required that the height dimensions partially vary.

For example, even when no thicker portion 15 (see FIG. 3) is provided, as in a battery pack 56 (see FIG. 4), it will be clear that the battery pack 56 may be accommodated in the battery pack accommodation apparatus 10. As a further example, reusable rechargeable batteries that are used for alternative purposes other than as rechargeable batteries for vehicles may be accommodated in the battery pack accommodation apparatus 10.

In the present exemplary embodiment, the interior of the battery pack accommodation apparatus 10 is enclosed. Therefore, even if the battery pack accommodation apparatus 10 is disposed outdoors, effects of wind and rain to the interior of the battery pack accommodation apparatus 10 may be suppressed. However, this is not limiting. Depending on a site at which the battery pack accommodation apparatus 10 is located, the battery pack accommodation apparatus 10 need not necessarily be enclosed.

Hereabove, an exemplary embodiment of the present disclosure has been described, but the present disclosure is not limited by this exemplary embodiment. The exemplary embodiment and various variant examples may be used in suitable combinations, and it will be clear that numerous modes may be embodied within a technical scope of the present disclosure.

### ADDITIONAL REMARKS

The structures described below may be suitably combined to serve as the vehicle framework member according to the present disclosure.

### —Structure 1—

A power supply apparatus for accommodating plural rechargeable batteries at multiple levels in a height direction, in which: the rechargeable batteries include a first rechargeable battery that includes a first region and a second region, the first region being provided substantially in a horizontal direction, and the second region being within the first region and being formed to be thicker, in the height direction, than the first region; and the power supply apparatus enables arrangement of the first rechargeable battery and a second rechargeable battery that is adjacent to the first rechargeable battery in the height direction such that the first rechargeable battery and second rechargeable battery are arranged to be offset in a length direction of the power supply apparatus such that the second rechargeable battery is disposed at the upper side or lower side of the first region excluding the second region of the first rechargeable battery, and a distance in the height direction between a floor face of the first rechargeable battery and a floor face of the second rechargeable battery is less than a thickness dimension of the second region.

### —Structure 2—

At least two pairs of attachments extend in the length direction of a power supply apparatus main body and support respective both end portions of the rechargeable batteries that are end portions of a direction substantially orthogonal to an insertion and removal direction of the rechargeable batteries. Each pair of attachments is formed to be shorter than a dimension of the power supply apparatus main body in the length direction of the power supply apparatus main body, and at least two pairs of the attachments that are disposed to be adjacent in the height direction are arranged to be offset in the length direction of the power supply apparatus.

### —Structure 3—

The power supply apparatus includes an insertion and removal aperture at which the rechargeable batteries are inserted and removed substantially horizontally in the length direction, the insertion and removal aperture being provided at one end side in the length direction of the power supply apparatus main body.

### —Structure 4—

The insertion and removal aperture is provided at the one end side and another end side in the length direction of the power supply apparatus main body.

### —Structure 5—

The second rechargeable battery includes a third region and a fourth region, the third region being provided substantially in the horizontal direction, and the fourth region being within the third region and being formed to be thicker, in the height direction, than the third region, and the first rechargeable battery and second rechargeable battery are configured to be arranged such that the second region and the fourth region are not vertically superposed.

### —Structure 6—

The second region is disposed at a rear side in the length direction of the power supply apparatus main body, and the fourth region is disposed at a front side of the power supply apparatus main body in the length direction of the power supply apparatus main body.

What is claimed is:

1. A power supply apparatus configured to accommodate a plurality of rechargeable batteries at multiple levels, in a height direction, of the power supply apparatus, wherein:
the plurality of rechargeable batteries comprise a first rechargeable battery that includes a first region and a second region, the first region being provided substantially in a horizontal direction at the first rechargeable battery, and the second region being within the first region and being formed to be thicker, in the height direction, than the first region;
the power supply apparatus enables arrangement of the first rechargeable battery and a second rechargeable battery that is adjacent to the first rechargeable battery in the height direction;
the first rechargeable battery and the second rechargeable battery are arranged to be offset in a front-rear direction of the power supply apparatus such that the second rechargeable battery is disposed at an upper side or a lower side of the first region excluding the second region of the first rechargeable battery; and
a distance, in the height direction, between a bottom face of the first rechargeable battery and a bottom face of the second rechargeable battery is less than a thickness dimension, in the height direction, of the second region of the first rechargeable battery.

2. The power supply apparatus according to claim 1, comprising:
a power supply apparatus main body; and
at least two pairs of attachments that extend in a front-rear direction of the power supply apparatus main body and that support respective both end portions, in a width direction, of the rechargeable batteries, the width direction of the rechargeable batteries being substantially orthogonal to an insertion and removal direction of the rechargeable batteries with respect to the power supply apparatus, wherein:
each pair of attachments is formed to be shorter than a dimension of the power supply apparatus main body, in the front-rear direction of the power supply apparatus main body, and
at least two pairs of the attachments that are disposed to be adjacent in the height direction are arranged offset in the front-rear direction of the power supply apparatus.

3. The power supply apparatus according to claim 1, further comprising an insertion and removal aperture at which the rechargeable batteries are inserted and removed substantially horizontally in the front-rear direction of the power supply apparatus,
wherein the insertion and removal aperture is provided at one end side of the power supply apparatus main body, in the front-rear direction of the power supply apparatus main body.

4. The power supply apparatus according to claim 3, wherein the insertion and removal aperture is provided at the one end side and another end side of the power supply apparatus main body, in the front-rear direction of the power supply apparatus main body.

5. The power supply apparatus according to claim 1, wherein:
the second rechargeable battery includes a third region and a fourth region, the third region being provided substantially in a horizontal direction at the second rechargeable battery, and the fourth region being within the third region and being formed to be thicker, in the height direction, than the third region, and
the first rechargeable battery and the second rechargeable battery are arranged such that the second region of the first rechargeable battery and the fourth region of the second rechargeable battery are not vertically superposed.

6. The power supply apparatus according to claim 5, wherein the second region is disposed at a rear side of the power supply apparatus main body, in the front-rear direction of the power supply apparatus main body, and the fourth region is disposed at a front side of the power supply apparatus main body, in the front-rear direction of the power supply apparatus main body.
